(19) United States
(12) Patent Application Publication
(10) Pub. No.: US 2026/0069897 A1
(43) Pub. Date: Mar. 12, 2026

(54) BELAY DEVICE AND METHOD OF USE

(71) Applicant: ZEDEL, Crolles (FR)

(72) Inventors: Alain Maurice, Le Plateau des Petites Roches (FR); Christophe Quillard, Eybens (FR); Pierre-Olivier Chabod, Pontcharra (FR)

(73) Assignee: ZEDEL, Crolles (FR)

(21) Appl. No.: 19/389,889

(22) Filed: Nov. 14, 2025

Related U.S. Application Data
(63) Continuation of application No. 17/872,475, filed on Jul. 25, 2022, now abandoned.

(30) Foreign Application Priority Data
Aug. 3, 2021 (FR) 2108451

(51) Int. Cl. A62B 1/14

(52) U.S. Cl. CPC A62B 1/14

(57) ABSTRACT

A belay device comprises a casing with an opening for a rope loop. A roller is inserted movable in the casing and mounted idle. The roller is mounted movable between first, second and third roller positions. A rotation clamp either allows free rotation of the roller or disables one rotation direction of the roller depending on the position of the roller in the casing. The rotation clamp allows free rotation when the roller is in the first roller position and disables one rotation direction of the roller when the roller is in the second and third roller position. A spring biases the roller to the first roller position and transforms a force on the roller into a position of the roller in the casing.

This application is a Continuation Application of U.S. Patent Application No. 17/872,475 filed July 25, 2022, which claims priority from French Patent Application No. 2108451 filed August 3, 2021, the entire disclosures of which is incorporated herein by reference.

### BACKGROUND OF THE INVENTION

The invention relates to a belay device and to the method of use thereof.

### State of the art

In mountaineering and in other mountain activities, it is commonplace to have a belay device inside which a rope passes attaching the climber and the belay device. Belay devices have to address two distinct issues. The belay device has to be easy to use, i.e. it has to be easy to make the rope run in the belay device in order to feed the person who is climbing with slack or on the contrary to take up the slack on the rope quickly. It is therefore necessary to have a rope channel that presents a low degree of friction.

The belay device also has to be secure proposing adjustable braking of the rope when the climber is descending and/or presenting assisted rope clamping. It is also advantageous for the belay device to be tolerant to improper handling and above all for it not to be too complex to handle.

These two requirements are technically rather contradictory due to the fact that, to provide adjustable braking or assisted rope clamping, it is necessary to have a part in continuous contact with the rope and with sufficient friction to detect the running conditions of the rope in the belay device. A trade-off therefore has to be made between safety and practicality of use when designing the belay device.

For example, belay devices of "tube" type such as those marketed by the applicant under the trade name "Reverso®" or "Verso" do not have assisted rope clamping or fall detection. The rope always has to be held firmly.

Cam belay devices also exist having a cam mounted in rotatable manner. The cam pivots between a first position where the rope is pinched between the cam and a clamping area and a second position where the distance between the cam and the clamping area is greater than the diameter of the rope thereby allowing the rope to slide. The rope runs inside the belay device and slides along the cam inducing friction. The shape of the cam and the shape of the rope channel in the belay device define the intensity of the friction of the rope. To feed rope to the climber, a certain dexterity has to be acquired to avoid making the cam rotate thereby preventing the rope from sliding. The intensity of friction changes according to the diameter of the rope and the degree of wear of the latter.

Document US2014/0262611 illustrates a configuration of a belay device that modifies the cam device. The belay device is a cam belay device, a part of the cam of which is formed by a rotating roller. The roller is mounted rotatable in both directions and has a clamping system of the roller when the speed of rotation of the roller is higher than a threshold speed. The angular speed of rotation of the roller represents the linear feed rate of the rope in the belay device. As in other cam devices, the rope slides along the cam and generates friction to actuate the cam when the tension in the rope increases. When the rope runs too quickly, the roller blocks which greatly increases the value of the friction between the rope and the cam and tends to actuate the cam. The device then operates as a cam device. This configuration proves difficult to implement as the friction coefficient between the rope and cam varies greatly according to the speed of rotation of the roller and the speed of rotation of the roller depends on the friction that exists with the rope. In other words, clamping of the rope by means of the cam is greatly dependent on the shape of the cam, on the diameter of the rope, and on the surface state of the rope and how the roller is integrated in the cam.

In another technical field, a safety fall arrest device equipped with a rotating roller is known from document FR2149047. The rope passes round the roller and, when the speed of rotation of the roller reaches a limit value, the roller blocks preventing progression of the rope. A substantially equivalent teaching is presented in document FR2513886.

Finally, roller-based belay devices are known having a roller in contact with the rope. The roller is mounted rotatable in both directions so as not to hamper the user in the rope feed phases according to the climber's requirements. The belay device marketed by Wild Country under the trade name Revo and presented in document US2016/0310767 is a belay device having a rope insertion opening, a rope outlet opening and a wheel that diverts the rope between the insertion opening and the outlet opening The deviation applied on the rope ensures a substantial contact between the rope and the wheel. The wheel is associated with a device for clamping the roller when the angular speed of rotation of the wheel reaches a threshold value. However, with use, it is apparent that descent control is not easy as there is little friction between the rope and the parts forming the belay device. It is also apparent that detection of the rate of descent is greatly dependent on the clogging present in the belay device in particular at the level of the ratchets that perform clamping of the wheel. Finally, the belay device is configured to clamp when the threshold speed is reached corresponding to a fall. In the same way as for a belay device of "tube" type, there is no way of performing secure static clamping the need for which may arise when the climber needs to rest or when he is performing work on the route.

In another technical field, roller devices are also known with a brake for rescue operations. Document US7,658264 can be cited that discloses a roller descender with a roller rotating in one rotation direction only. The roller is configured to rotate when the rope is pulled to raise an injured person and to clamp when the rope is no longer pulled. When the pull on the rope is ceased, the brake engages to clamp the rope. To lower the injured person, a knob has to be turned moving the brake allowing the rope to slide. The device is cumbersome and heavy as it is designed for rescue operations. It is not suitable for belaying a climber. In the same technical field, it is known from document US7419138 to form a rescue device with a roller that rotates in one direction only. The roller is mounted eccentrically to move towards or away from a pad so that the rope is jammed between the pad and the roller. When the rope is pulled to raise the injured person, the roller moves away from the pad and the roller rotates on itself. When the rope is no longer pulled, the roller clamps as rotation in the other direction is forbidden and the roller moves towards the pad to clamp the rope. When no force is applied, the roller is in contact or almost in contact with the pad. A handle is actuated to move the roller and adjust sliding of the rope between the roller and clamp. Document US10828516 can also be cited with a roller associated with a clamp installed facing a pad. There again, the roller rotates in one direction only and the handle moves the clamp to adjust sliding of the rope between the clamp and the pad.

### SUMMARY OF THE INVENTION

One object of the invention consists in this remedying these shortcomings, and more particularly in providing a belay device that is able to clamp the rope in more secure manner without generating too much friction with the rope when it is necessary to take up the slack from the climber or to feed rope to the climber.

This result tends to be achieved by means of a belay device that comprises: - a casing designed to receive a rope loop, the casing defining an attachment point designed to attach the belay device to an anchor point and at least one opening for the strands of the rope loop to pass through, - a pad delineating the at least one opening; - a roller arranged in the casing and mounted rotatable in both rotation directions, the roller also being mounted movable in the casing in a first direction of movement between a first roller position, a second roller position and a third roller position, the second roller position being nearer to the opening than the first roller position, the third roller position being nearer to the pad than the second roller position, the roller being designed to be in contact with the rope loop over at least 40% of its perimeter, - a rotation clamp configured to allow rotation of the roller in both rotation directions or to prevent at least one rotation direction of the roller depending on the position of the roller in the casing, the rotation clamp being configured to allow rotation of the roller in the two opposite rotation directions when the roller is in the first roller position and to prevent at least one rotation direction of the roller when the roller is in the second roller position and when the roller is in the third roller position, - a first spring having a first end attached toward the casing and a second end attached to the roller to bias the roller toward the first roller position, the first spring transforming a force of the rope loop on the roller into a position of the roller in the casing, - a handle fitted movable between a first handle position and a second handle position, wherein, in the third roller position, the handle is functionally coupled to the casing and to the roller so that a force applied on the handle to move the handle generates a force on the roller in the direction of the second roller position.

According to one feature of the invention, the roller is provided with a toothed wheel and a hook is mounted on the casing, the toothed wheel being in contact with the hook when the roller is in the second roller position and the toothed wheel being at a distance from the hook when the roller is in the first roller position, the hook and toothed wheel forming the rotation clamp.

Preferentially, the hook is mounted movable with respect to the casing between a first hook position and a second hook position. When the hook is in a first hook position and the roller is in the second roller position, the toothed wheel is in contact with the hook. When the hook is in a second hook position and the roller is in a third roller position, the toothed wheel is in contact with the hook.

According to another feature, a hook spring applies a force on the hook, the hook spring placing the hook in the first hook position in the absence of any outside force being applied.

In advantageously manner, the handle is configured to move the roller to the second roller position so that actuation of the handle does not enable rotation of the roller in both rotation directions.

It is particularly advantageous to provide for the pad to partially obstruct a groove of the roller when the roller is in the third roller position.

In an advantageous configuration, an additional rotation clamp is configured to prevent rotation of the roller when its speed of rotation reaches a threshold value.

In a preferential development, the roller rotates around a first rotation shaft. The first spring is configured to adjust the space occupied by the rotation shaft perpendicularly to the axis of rotation of the roller, the first spring being configured to apply a force on the rotation shaft and to shift the axis of rotation and the roller in the direction of the first roller position.

It is a further object of the invention to provide a method for using a belay device that is easier to implement than the methods of the prior art. This result tends to be achieved by means of a method for using a belay device comprising the following steps: - providing a belay device according to any one of the foregoing configurations, - installing a rope loop in the belay device, the rope loop passing round the roller, - the tension in the rope being lower than a first threshold value, making the rope run in one direction and then in the opposite direction to cause rotation of the roller in one rotation direction and then in the other rotation direction; - increasing the tension in the rope until the roller reaches the second roller position, the roller blocking at least one rotation direction, - further increasing the tension in the rope until the rope is clamped.

### DESCRIPTION OF THE DRAWINGS

Other advantages and features will become more clearly apparent from the following description of particular embodiments and implementation modes of the invention given for non-restrictive example purposes only and represented in the appended drawings, in which:

- FIG. 1 schematically illustrates a first embodiment of a belay device according to the invention without the cover and in a position allowing sliding of the rope and rotation of the roller in two opposite directions;

- FIG. 2 schematically illustrates the belay device of FIG. 1 in a position allowing rotation of the roller in one direction only and sliding of the rope;

- FIG. 3 schematically illustrates the belay device of FIG. 1 in a position designed to clamp the rope and allowing rotation of the roller in one direction only;

- FIG. 4 schematically illustrates a cross-section of the belay device represented in FIG. 1;

- FIG. 5 schematically illustrates a cross-section of the belay device represented in FIG. 1 with a detector of the speed of rotation of the roller in the clamped position;

- FIG. 6 schematically illustrates an exploded view of the belay device represented in FIG. 1;

- FIG. 7 schematically illustrates the belay device represented in FIG. 1 with the cover closing the belay device;

- FIG. 8 schematically illustrates another embodiment of a belay device with the cover closing the belay device;

- FIG. 9 schematically illustrates an exploded view of the belay device represented in FIG. 8;

- FIG. 10 schematically illustrates the belay device illustrated in FIG. 8 without the cover and in a position allowing sliding of the rope and rotation of the roller in two opposite directions;

- FIG. 11 schematically illustrates the belay device of FIG. 10 in a position allowing sliding of the rope and clamping of the roller at least in one direction;

- FIG. 12 schematically illustrates the belay device of FIG. 10 in a position designed to clamp the rope and possibly allowing rotation of the roller in one direction only;

- FIG. 13 schematically illustrates the support and roller of the belay device illustrated in FIG. 10 without the cover and in a position allowing rotation of the roller in two opposite directions;

- FIG. 14 schematically illustrates the support and roller of the belay device illustrated in FIG. 10 without the cover and in a position blocking at least one rotation direction of the roller by pivoting of the roller;

- FIG. 15 schematically illustrates an exploded view of the support and roller of the belay device illustrated in FIGS. 10 to 14;

- FIG. 16 schematically illustrates an exploded view of another embodiment of the support and roller of the belay device illustrated in FIG. 10;

- FIG. 17 schematically illustrates a cross-section of the support and roller of the belay device illustrated in FIG. 13, the rotation shaft having a maximum space occupation;

- FIG. 18 schematically illustrates a cross-section of the support and roller of the belay device illustrated in FIG. 16, the rotation shaft having a minimum space occupation.

### DETAILED DESCRIPTION

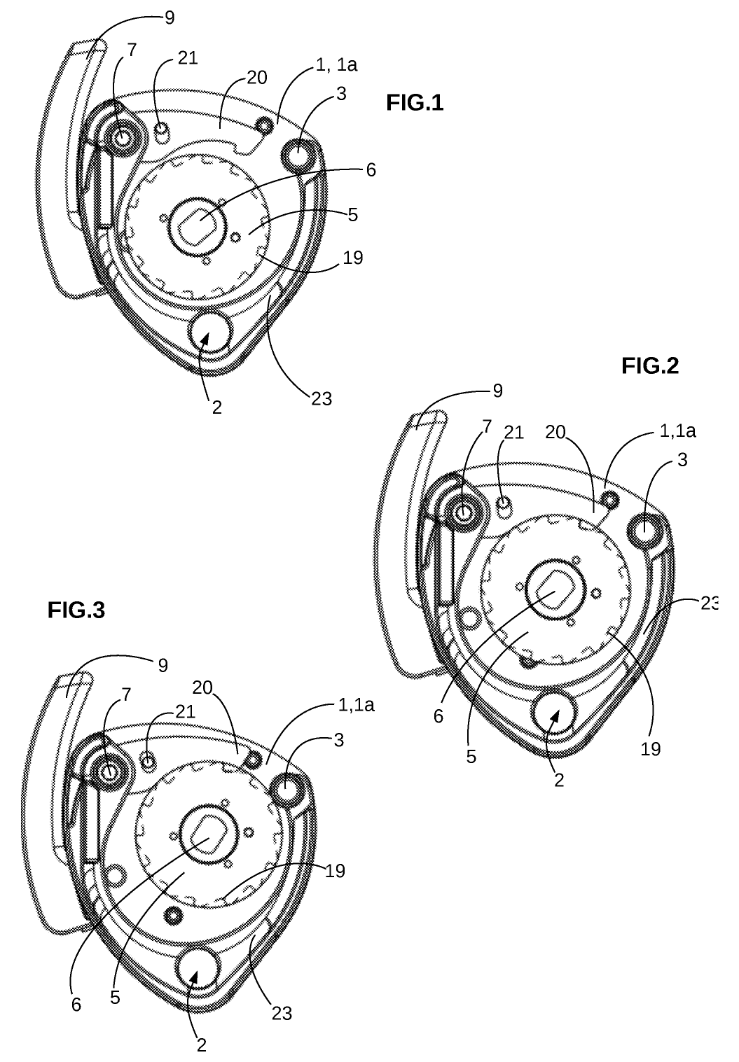

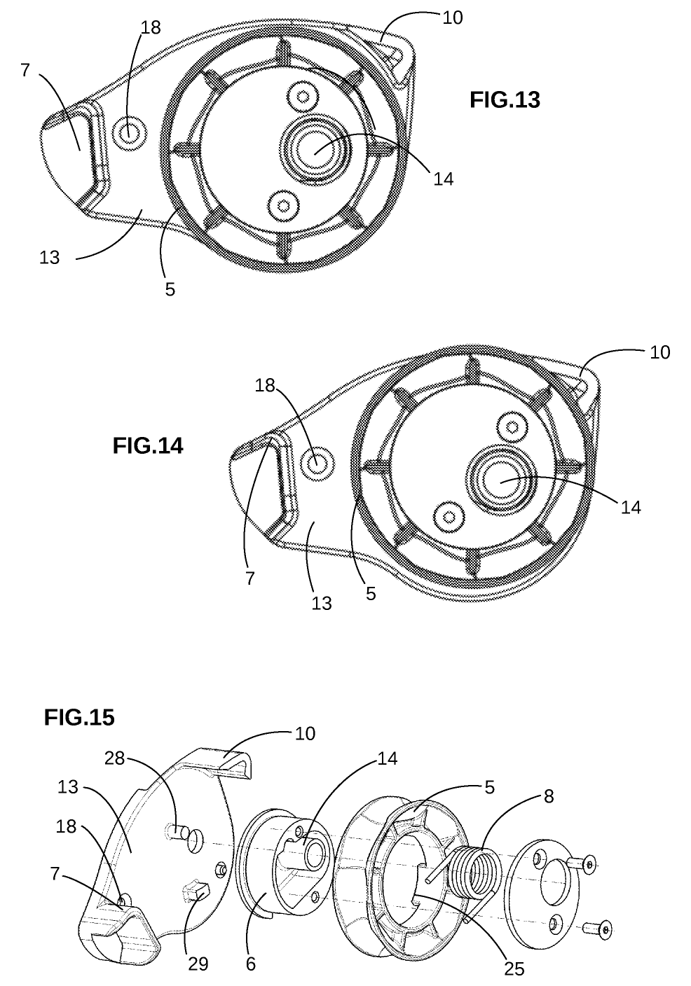

FIGS. 1 to 18 illustrate different embodiments of a belay device. The belay device is preferably a self-clamping belay device, i.e. it is configured to clamp the rope when the stress in the rope inside the belay device is greater than a limit value. Once the rope is clamped, the user has to perform a specific action to enable sliding of the rope inside the belay device. When the user ceases this action, the belay device again clamps the rope if the tension is higher than the limit value.

The belay device has a casing designed to receive a rope loop. The casing is preferentially openable to enable the rope loop to be easily inserted. The casing defines at least one opening to let the strands of the rope loop pass through. In the illustrated embodiments, the casing defines a single opening, but it is also possible for the casing to define two openings.

In a particular embodiment, the casing is partly formed by the first flange 1. The first flange 1 is preferentially substantially flat. The casing and preferentially the first flange 1 define or have an attachment point 2 designed to attach the belay device to an anchor point. The anchor point can be the user's harness but it is possible to use another element to form the anchor point.

In the illustrated embodiments, the attachment point 2 is formed by a hole that is a through hole inside the first flange 1. A carabiner or any other type of connector passes through the hole to attach the belay device to the user. The attachment point 2 can also be formed by a connector of the belay device, for example a carabiner.

A pad 3 forming a first clamping area is present in the casing and preferentially delineates the at least one opening of the casing. In the illustrated embodiments, the pad 3 extends salient from a first surface 1a of the first flange 1 in a first direction. The first direction is perpendicular or substantially perpendicular to the first surface 1a to form a salient area. The pad 3 is designed to clamp the rope in the belay device. According to the preferential embodiments, the pad 3 is formed with the rest of the first flange 1 or the pad 3 is fixed to the first flange 1. The pad 3 can be secured to the first flange 1 by means of a nut 3a In preferential manner, the casing has a the second flange 4 mounted movable and/or removable with respect to the first flange 1 which makes the rope easier to insert. The second flange 4 closes the space designed to receive the rope and can partly delineate the opening.

The belay device has a roller 5 presenting two distinct movements in the casing. On the one hand, the roller 5 is mounted idle, i.e. rotating in two opposite rotation directions. The roller 5 is mounted rotatable around a first rotation shaft 6 that defines a first axis of rotation. The first axis of rotation of the roller 5 passes through the centre of the roller 5. When the rope loop is installed in the belay device, the rope loop passes round the roller 5 so that the rope is in contact with the groove of the roller 5. The rope passes round the roller 5 coming into contact with the roller 5 over a distance equal to at least a quarter of the perimeter, preferably at least a third of the perimeter and even more preferentially at least 40% or at least a half of the perimeter.

It is particularly advantageous to have a roller 5 that is able to move in the two opposite rotation directions as this facilitates running of the rope inside the belay device during the two running phases of the rope, to feed the rope to the climber or on the contrary to take the rope slack up with a low friction force.

On the other hand, the roller 5 is mounted movable in the casing to move towards or away from the opening and/or the pad 3. In other words, the first rotation shaft 6 is mounted movable in the casing to move towards or away from the opening. The axis of rotation of the roller 5 shifts with respect to the first flange 1.

The opening of the casing is delineated by two delineators 7, one delineator 7 preferentially being formed by the pad 3. The rope loop exits from the belay device pressing on the two delineators 7 and passing round the roller 5.

The roller 5 is mounted movable so as to be able to move inside the casing in addition to its rotation. The roller 5 is mounted movable so as to be able to move between several positions. In a first direction of movement, the roller 5 moves between a first roller position, a second roller position and a third roller position. The second roller position is located between the first roller position and the third roller position. The second roller position is nearer to the opening than the first roller position and may be nearer to the pad 3 than the first roller position. The third roller position is nearer to the pad 3 than the second roller position and may be nearer to the opening than the second roller position.

The belay device has a rotation clamp that is configured to allow rotation of the roller 5 in both rotation directions or to block at least one of the two rotation directions depending on the position of the roller 5 inside the casing. In one particular case, the rotation clamp is configured to allow rotation in both rotation directions or to allow rotation in one rotation direction only depending on the position of the roller 5 inside the casing. In another particular case, the rotation clamp is configured to allow rotation in both rotation directions or to block rotation in both rotation directions depending on the position of the roller 5 inside the casing

The rotation clamp is configured to allow rotation of the roller 5 in the two opposite rotation directions when the roller 5 is in the first roller position. The rotation clamp is configured to allow rotation of the roller 5 in one rotation direction only or to prevent rotation when the roller 5 is in the second roller position. The rotation clamp is configured to allow rotation of the roller in one rotation direction only or to prevent rotation when the roller 5 is in the third roller position.

The rotation clamp of the roller can be formed by any suitable means. Depending on the configurations, the rotation clamp can act by clamping the roller 5 and/or it can act by clamping rotation shaft 6 of the roller 5.

The belay device has a first spring 8 that connects the roller 5 and the casing, preferably the first spring 8 connects the roller 5 and flange 1. The first spring 8 is formed by one or more parts that deform elastically. The first spring 8 biases the roller 5 so as to place the roller 5 in the first roller position if no outside force is applied. The first spring 8 is configured to oppose movement of the roller 5 from the first roller position to the second roller position or the third roller position. The first spring 8 transforms a predefined force applied on the roller 5 in the direction of the opening into a predefined position in the casing. The first spring 8 transforms a tension in the rope and therefore a force applied on the roller 5 into a position of the roller inside the casing.

The first spring 8 and the rotation clamp together form a clamping system that is configured to block rotation of the roller 5 according to the force applied on the roller 5 in the direction of the opening. The tension present in the rope inside the belay device results in a force being applied on the roller 5 by the rope. Depending on the value of the force applied by the rope on the roller, the roller 5 moves allowing rotation of the roller in the two rotation directions or blocks at least one rotation direction. The first spring 8 associated with the rotation clamp enables the behaviour of the roller 5 to be modified according to the position of the roller 5 in the casing and therefore according to the force applied on the roller 5.

As the force applied on the roller 5 progressively increases and opposes the force applied by the first spring 8, the roller 5 moves from the first roller position to reach the second roller position and then the third roller position. When the roller 5 is subjected to a lower force than a first threshold value, the roller 5 is in the first roller position. When the force applied on the roller 5 increases and reaches the first threshold value, the roller 5 reaches the second roller position. If the force increases further, the roller 5 moves until it reaches the third roller position.

In preferential manner, the first spring 8 defines a mechanical link connecting the roller 5 and the first flange 1. The first spring 8 enables the first force threshold value to be defined. The first spring 8 can directly connect the first flange 1 and the roller 5 or preferentially rotation shaft 6 of the latter. However, it is also possible to provide one or more intermediate parts in the mechanical link connecting the roller 5 and the casing or the first flange 1. For example, the first spring 8 is fixed on the one hand to the first flange 1 and on the other hand to an intermediate part itself connected to the roller 5, or the first spring 8 is fixed on the one hand to the roller 5 and on the other hand to an intermediate part fixed to the first flange 1. The first spring 8 can be formed by any suitable means, for example a torsion, compression, extension or flexion spring. The first spring 8 can be a coil spring or a leaf spring.

When the roller 5 is in the first roller position which corresponds to a weak force and therefore a weak tension applied by the rope, the roller 5 can rotate in both its rotation directions. This configuration enables the rope to run easily in both directions. As the tension in the rope gradually increases, the roller 5 moves towards the opening until it reaches the second roller position. When the roller reaches the second roller position, the roller 5 can no longer rotate in both directions. The roller 5 can rotate in one direction only or can no longer rotate at all. Blocking of the roller in at least one of the rotation directions enables the friction between the rope and the roller 5 to be increased. The increased friction between the rope and the roller 5 enhances the sensitivity of the roller 5 as regards the behaviour of the rope. The small variations of tension in the rope are better perceived by the roller 5 thereby facilitating clamping of the rope by the belay device.

The axis of rotation and more generally the roller 5 move with respect to the first flange 1 due to the action of a force applied by the rope on the roller 5. The greater the force present in the rope, the greater the force applied on the roller 5 pulling the roller towards the opening and towards the pad. Movement of the roller 5 tends to reduce the available space for a rope strand to pass through.

Once the second roller position has been reached, the roller 5 can be able to rotate in one direction only corresponding to take-up of the rope from the climber or not present any rotation. The roller 5 can rotate to allow easy take-up of the rope from the climber thereby improving safety. On the other hand, the roller cannot rotate in the direction that feeds rope to the climber which means that the rope can be kept clamped and facilitates locking and even self-locking of the rope.

The third roller position is nearer to the pad 3 than the second roller position. As the roller 5 progressively moves towards the pad 3, the space available for running of the rope strand attached to the climber is reduced which increases the friction until clamping of the rope is achieved. The reduction of the available space increases the friction between the rope and the roller 5 making the roller more sensitive to the tension in the rope.

For ease of running of the rope in the belay device, it is preferable for the rope to come into contact with a minimum number of components forming the belay device. For example, the rope only comes into contact with the roller 5 and with the two delineators 7 that form the two outgoing contact points of the rope. Preferentially, the belay device is not provided with a locking cam in continuous contact with the rope. Such a locking cam introduces considerable friction on the rope which complicates use of the belay device.

The force applied on the roller 5 moves the roller 5 in the casing and changes its behaviour. The position of the roller 5 in the casing is defined by the force applied on the roller 5. Blocking of the roller 5 in one rotation direction ensures sufficient friction between the roller 5 and the rope so as to obtain clamping of the rope. The belay device has a rope clamp 10 that is mounted movable in the casing. The rope clamp 10 moves with respect to the pad 3 either towards or away from the pad 3. In one position, the rope clamp 10 is quite close to the pad 3 to clamp the rope between the pad 3 and the rope clamp 10. The rope clamp 10 is functionally attached to the roller 5 so that the position of the rope clamp 10 follows the position of the roller 5 and vice versa between the second roller position and the third roller position.

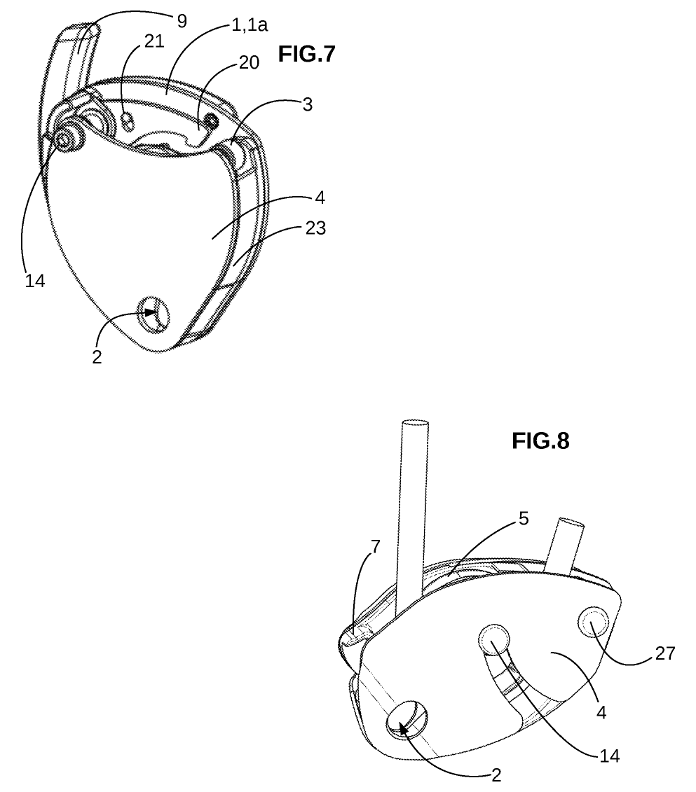

Different configurations of the rope clamps 10 are possible. In the embodiment of FIGS. 1 to 7, the roller 5 forms the rope clamp 10. In the embodiment of FIGS. 8 to 18, the rope clamp 10 is formed by an additional pad. In the second roller position, the roller 5 reaches a stop mechanically connecting the rope clamp 10 and the roller so that movement of the roller 5 between the second roller position and the third roller position results in movement of the rope clamp 10. Preferentially, when the roller 5 is between the second roller position and the third roller position, the position of the roller and the position of the rope clamp are linked in bijective manner.

In the particular case illustrated in FIGS. 8 to 18, the roller 5 moves until it comes into contact with the rope clamp 10. When the roller 5 reaches the stop on the rope clamp 10, the roller 5 is in the second roller position. Movement of the roller 5 from the second roller position to the third roller position results in movement of the rope clamp 10 in the direction of the pad 3 to reduce the distance between the pad 3 and the rope clamp 10 until clamping of the rope is achieved.

The belay device comprises a handle 9 that is functionally connected to the roller 5 and to the rope clamp 10. The handle 9 can be connected directly to the rope clamp 10 or to the roller 5. The handle 9 is able to move between a first handle position and a second handle position. When the roller 5 is in the third roller position corresponding to a minimum distance between the rope clamp 10 and the pad 3, rotation of the handle 9 makes the rope clamp 10 move away from the pad 3.

The mechanical connection between the handle 9 and the roller 5 means that the force applied on the handle 9 to make the latter rotate in the first rotation direction of the handle gives rise to a force on the roller 5 moving the latter away from the third roller position to the second roller position. The force applied on the handle 9 moves the rope clamp 10 away from the pad 3. The rope will be able to slide between the rope clamp 10 and the pad 3.

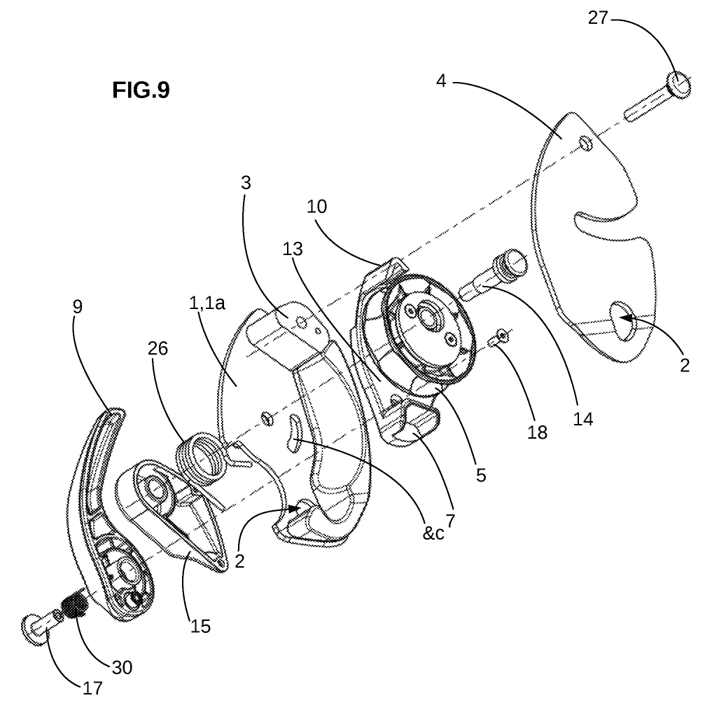

In the examples illustrated in FIGS. 9 to 18, the handle 9 has a mechanical link with the first flange 1 and with the rope clamp 10 to move the rope clamp 10 with respect to the pad 3. Depending on the embodiments, the handle 9 can be fitted on the first flange 1, on the rope clamp 10 or on an intermediate part connected to the first flange 1 and to the rope clamp 10 or to another part of the casing. Numerous configurations are possible.

It is particularly advantageous for actuation of the handle 9 not to allow the roller 5 to be moved beyond the second roller position in an opposite direction of movement to the first direction of movement to prevent the roller 5 from reaching the first roller position and to allow free rotation of the roller 5.

As indicated in the foregoing, the belay device allows rotation of the roller 5 in both rotation directions depending on the position of the roller 5 with respect to the first flange 1 or in one direction only, or even prevents any rotation. The position of the roller 5 with respect to the first flange 1 is defined by the force applied on the roller 5. Such a configuration is absent from the prior art. This configuration enables clamping of the rope independently from the feed rate of the rope and independently from the feed direction of the rope.

Document US2014/0262611 does not disclose a relation between the tension in the rope and clamping of the roller 5, or a relationship between the force applied on the roller 5 and therefore on the cam and clamping of the roller 5. According to document US2014/0262611, rotation or clamping of the cam only takes place when the rope runs too quickly in the configuration which corresponds to a fall. A substantially identical conclusion can be drawn as regards the belay device marketed by Wild Country under the trade name Revo. Clamping of the rope is tied to the speed of rotation of the roller 5 independently from the tension present on the rope.

In advantageous manner, in order to better detect if a climber falls, the belay device can be provided with an additional rotation clamp that is configured to block rotation of the roller when the speed of rotation of the roller reaches a threshold value. This additional blocking is only linked to the speed of rotation and is independent from the force applied on the roller.

Different embodiments are possible to obtain such a result. In a particular embodiment illustrated in FIGS. 1 to 7, the rope clamp 10 is formed by the roller 5. The first roller position is illustrated in FIG. 1. As indicated in the foregoing, with a low tension in the rope, the roller 5 can rotate in both directions which means that the rope can run easily in both directions. When the roller 5 is subjected to a higher force corresponding to the first threshold value, the roller 5 moves and reaches the second roller position illustrated in FIG. 2. The roller 5 is allowed to rotate in one rotation direction only. The roller 5 can rotate to take up rope from the climber.

When the roller 5 is subjected to an even higher force than the first threshold value, the roller 5 reaches third roller position 5 that is even nearer to the pad 3. In the third roller position, the roller 5 and the pad 3 are able to clamp a rope that is installed in the belay device.

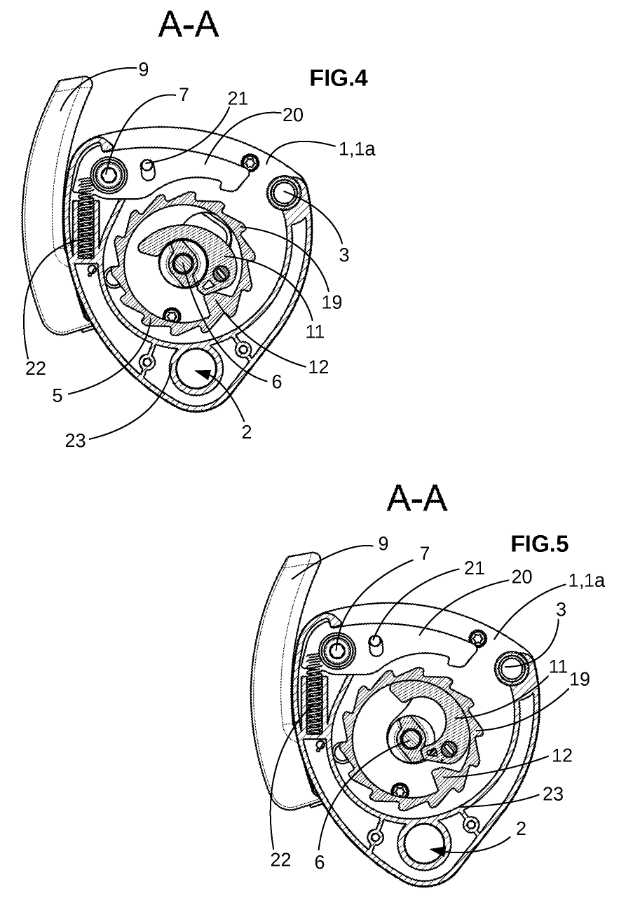

In an advantageous embodiment, for example the one illustrated in FIGS. 4 and 5, the roller 5 also has detectors configured for detecting the speed of rotation of the roller 5 that preferably forms an additional rotation clamp. The detectors are configured to prevent rotation of the roller 5 when the speed of rotation of the roller 5 reaches a threshold speed. The additional rotation clamp can have a latch 11 mounted movable and a pin 12 that is salient. The latch 11 is mounted movable between a position where the latch 11 is pushed down and enables rotation of the roller 5 and a position where the latch 11 is pulled out preventing rotation of the roller 5. The latch 11 can be associated with a latch spring 11a that biases the latch 11 to the pushed-down position and that defines the force to be overcome, i.e. the minimum speed of rotation, to pull the latch 11 out. Once the latch 11 is pulled out, it comes into contact with pin 12 which clamps the roller 5. The latch 11 can press on the first rotation shaft 6 in the pulled-out position to prevent rotation of the roller 5, the first rotation shaft 6 being fixedly mounted. FIG. 4 illustrates the latch 11 in the pushed-down position whereas FIG. 5 illustrates the latch 11 in the pulled-out position. The latch 11 is advantageously mounted rotatable around a latch shaft 11b, for example formed by a screw. Other embodiments of the additional rotation clamp are possible.

The use of an additional rotation clamp is advantageous to detect fast running of the rope and reduce the risks of injuries.

Advantageously, in the embodiment illustrated in FIGS. 1 to 7, the roller 5 rotates around the first rotation shaft 6 and the first spring 8 is configured to apply a force on the first rotation shaft 6 and to move the first rotation shaft 6 and the roller 5 in the direction of the first roller position. In the absence of any bias, the first spring 8 applies a force on the first rotation shaft 6 so that the roller 5 is in the first roller position.

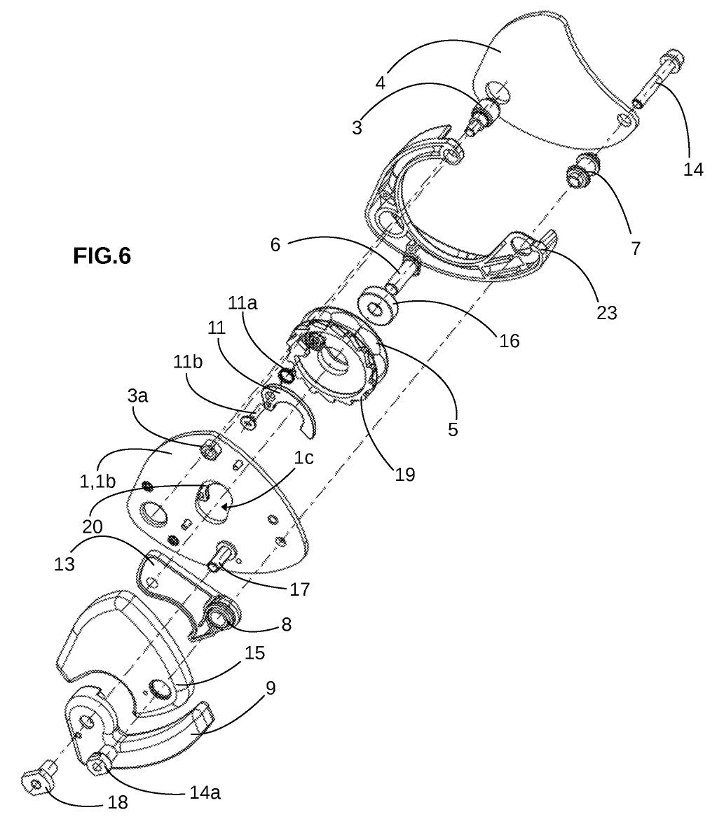

In preferential manner and as illustrated in FIG. 6, the first rotation shaft 6 is fixed on a support 13 that is mounted movable with respect to the first flange 1. The first spring 8 is configured to apply a force on the support 13 to move the roller 5 in the direction of the first roller position. In the particular example illustrated, the support 13 is mounted movable in rotation but another movement is possible. In the illustrated configuration, the support 13 is mounted movable in rotation around a the support rotation shaft 14 fixed to the first flange 1. The first spring 8 is fixed on the one hand to the first flange 1 and on the other hand to the support 13 and applies a force on the support 13 to place the roller 5 in the first roller position.

In advantageous manner, the support 13 is separated from the roller 5 by the first flange 1. The first rotation shaft 6 is fixed to the support 13 and passes through an aperture 1c of the first flange 1. Preferentially, the aperture 1c is configured so that the first rotation shaft 6 presses on one end of the aperture 1c when the roller 5 is in the first roller position and the first rotation shaft 6 presses on the opposite end of the aperture 1c when the roller 5 is in the third roller position. It is also preferable for the aperture 1c to always be completely covered by the roller 5.

The support rotation shaft 14 can also form the axis of rotation of the second flange 4 with respect to the first flange 1. The support rotation shaft 14 can also serve the purpose of fixing a cladding 15 on second face 1b of the first flange 1 to protect the support 13.

The support rotation shaft 14 can further act as rotation shaft for an additional roller forming the delineator 7 opposite the pad 3. The support rotation shaft 14 can collaborate with a nut 14a to fix the support rotation shaft 14 on the first flange 1.

It is also advantageous for the roller 5 to be mounted on a bearing 16, for example a ball-bearing or other bearing, to facilitate rotation of the roller 5 around the first rotation shaft 6. In the embodiment illustrated in FIG. 6, the handle 9 is mounted rotating around a third rotation shaft 17 fixed to the first flange 1. The handle 9 is fixed on the first flange 1 by means of a nut 18. The handle 9 slides along a ramp of the support 13 to move the support 13 and therefore the roller 5. Actuation of the handle 9 acts on the distance between the roller 5 and the pad 3 without acting on blocking of the roller 5 in at least one of its two rotation directions.

In an advantageous embodiment illustrated in FIGS. 1 to 7, the roller 5 is provided with a toothed wheel 19 and a hook 20 is mounted on the first flange 1. The toothed wheel 19 is in contact with the hook 20 when the roller 5 is in the second roller position. The toothed wheel 19 is at a distance from the hook 20 when the roller 5 is in the first roller position. In the illustrated embodiment, the contact between the hook 20 and the toothed wheel 19 allows rotation of the roller 5 in one rotation direction only. A lack of contact between the toothed wheel 19 and the hook 20 allows rotation of the roller 5 in both rotation directions. By modifying the shape of the teeth of the toothed wheel 19 and by modifying the shape of the hook 20, it is possible to prevent rotation of the roller 5 in both directions. The use of a toothed wheel 19 associated with a hook 20 is particularly advantageous as it is simple to achieve and its operation is rugged.

To form the rotation clamp, numerous other configurations are possible enabling rotation of the roller 5 in both rotation directions, or preventing at least one rotation direction depending on the position of the roller 5. It is possible to have a roller 5 mounted rotatable around the first rotation shaft 6 in the first rotation direction only and to have a first rotation shaft 6 mounted rotatable in the second direction or in both rotation directions. Movement of the roller 5 corresponds to a movement of the first rotation shaft 6. When the roller 5 reaches the second roller position, the first rotation shaft 6 clamps only allowing rotation of the roller 5 in the first rotation direction. For example, if the first rotation shaft 6 is mounted on the support 13 as illustrated in FIG. 5, it is possible to use a first rotation shaft 6 with a non-circular cross-section and an aperture 1c that prevents rotation of the first rotation shaft 6 when the second roller position is reached. The aperture 1c can be replaced by a hook that grips the first rotation shaft 6.

When the roller 5 is equipped with a toothed wheel 19, it is particularly advantageous to have a hook 20 mounted on the first flange 1 and preferentially a hook 20 mounted movable to follow the movement of the roller 5 beyond the second roller position. The toothed wheel 19 is in contact with the hook 20 when the roller 5 is in the second roller position and until the third roller position is reached. The toothed wheel 19 is at a distance from the hook 20 when the roller 5 is in the first roller position. A stop 21 prevents the hook 20 from remaining in contact with the toothed wheel 19 beyond the second roller position. The contact between the hook 20 and the toothed wheel 19 allows rotation of the roller 5 in one rotation direction only. In the illustrated example, the hook 20 forms a through hole and the stop 21 passes through the through hole to define the amplitude of the movements of the hook 20. Other configurations of a stop are possible. In preferential manner, the hook 20 is mounted rotatable.

Preferentially, the hook 20 is mounted movable with respect to the first flange 1 between a first hook position and a second hook position. When the hook 20 is in the first hook position and the roller 5 is in the second roller position, the toothed wheel 19 is in contact with the hook 20. When the hook 20 is in the second hook position and the roller 5 is in a third roller position, the toothed wheel 19 is in contact with the hook 20. Movement of the roller 5 between the second roller position and third roller position results in movement of the hook 20 which remains in contact with the toothed wheel 19 to prevent rotation of the roller 5 in at least one of the two rotation directions. Preferentially, actuation of the handle 9 does not modify the contact between the hook 20 and the toothed wheel 19.

It is advantageous to provide a spring 22, called hook spring, that applies a force on the hook 20. The hook spring 22 places the hook 20 in the first hook position in the absence of any outside force being applied. In the embodiment illustrated in FIGS. 1 to 7 and more particularly illustrated in FIG. 6, it can be noted that the casing is formed by a first flange 1 on which a frame 23 is mounted. The frame 23 separates the first flange 1 and the second flange 4 and partly demarcates the casing. The latch 11 is mounted rotatable around a latch rotation shaft 11b fixed to the roller 5.

The embodiment illustrated in FIGS. 1 to 7 has a simple movement of the roller 5 which is mounted with simple rotation around the support rotation shaft 14. The embodiment of FIGS. 8 to 15 presents an identical or substantially identical operation with a complex movement of the roller 5 which moves with respect to the support 13 and with the support 13 which moves with respect to the first flange 1.

FIGS. 8 to 15 illustrate a roller 5 that clamps against the rope clamp 10 but the use of a hook or an equivalent means is possible to prevent rotation of the roller 5.

FIG. 15 illustrates an embodiment in which the roller 5 is mounted rotatable around a first rotation shaft 6. The first rotation shaft 6 is mounted rotatable around a second rotation shaft that is formed here by the support rotation shaft 14. The first rotation shaft 6 is mounted movable between the first roller position and the second roller position.

The support 13 that is equipped with the rope clamp 10 is mounted rotatable around the support rotation shaft 14. The first rotation shaft 6 is connected to the support 13 by means of a first spring 8. The first spring 8 is connected on the one hand to the support 13 and on the other hand to the first rotation shaft 6. Spring 8 is configured to apply a force biasing the first rotation shaft 6 and therefore the roller 5 to first roller position 5.

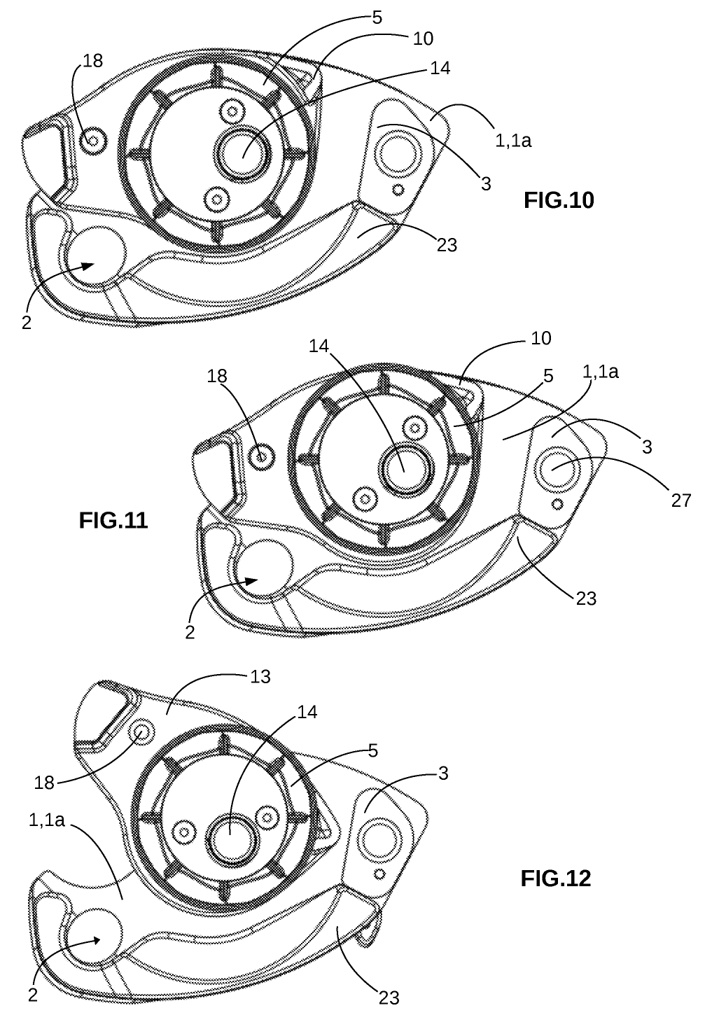

As illustrated in FIGS. 10 and 11, the force applied on the roller 5 in the direction of the opening, such as can be achieved by a rope loop that is stretched, results in movement of the roller 5 in the casing and movement of the roller 5 with respect to the support 13. The roller 5 moves until it comes up against the stop formed by the rope clamp 10. When the force on the roller 5 increases, the support 13 swivels having the effect of moving the rope clamp 10 towards the pad 3 to clamp the rope. In preferential manner, spring 8 has a lower stiffness than the spring 26 so that the roller 5 moves more than the support 13 when the roller 5 is subjected to a force in the direction of the opening. Depending on the required movements of the support 13 and the roller 5, the stiffness values and arrangements of the springs 8 and 26 can be adjusted. It is also possible to provide for the rotation shaft of the roller 5 to be different from the rotation shaft of the support 13.

In the embodiment illustrated in FIG. 15, the support 13 has a pin 28 mounted salient that inserts in the first rotation shaft 6. Spring 8 presses against the pin 28. The first spring 8 applies a force that is designed to press the first rotation shaft 6 against a stop 29 of the support 13 to define the first roller position. This embodiment is simple to implement and efficient for defining the threshold tension that triggers clamping of the roller and rotation of the support 13 to adjust the friction on the rope by means of the rope clamp.

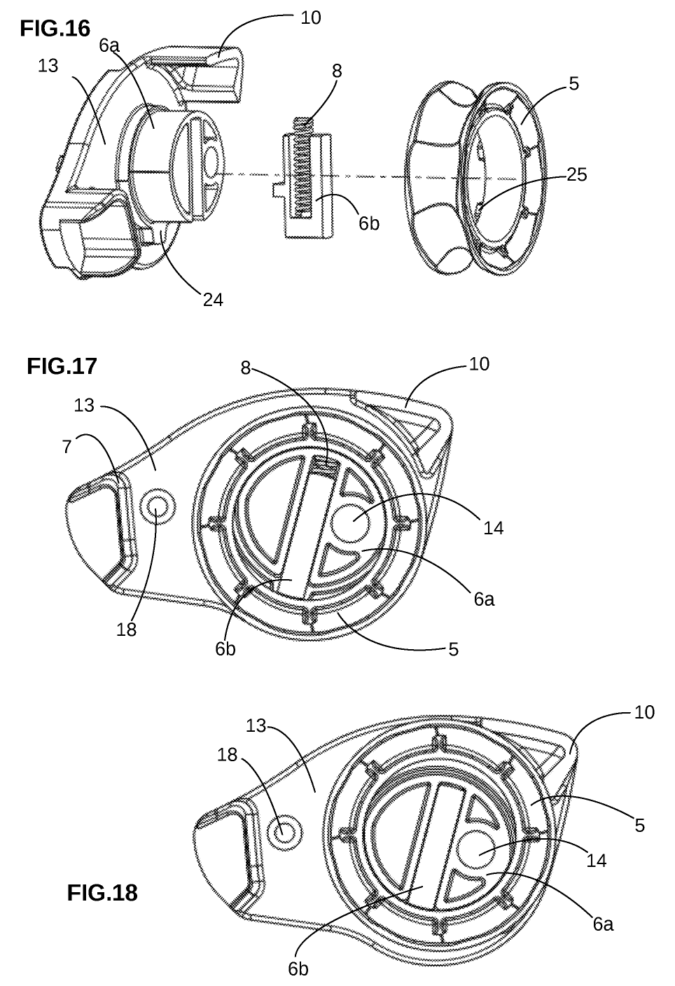

In another embodiment, movement of the roller 5 between the first roller position and the second roller position is obtained by means of a first rotation shaft 6 with variable space occupation or a rotation shaft mounted movable with respect to the support 13. An exemplary embodiment of a rotation shaft with variable space occupation is illustrated in FIGS. 16 to 18. The first rotation shaft 6 has a main portion 6a and a secondary portion 6b. the secondary portion 6b is mounted movable with respect to main portion 6a between a first position and a second position. In the first position illustrated in FIG. 17, the secondary portion 6b extends salient from main portion 6a over a first distance. The first rotation shaft 6 has a first space occupation value that corresponds substantially to a first apparent diameter. In the second position illustrated in FIG. 18, the secondary portion 6b extends salient from the main portion 6a over a second distance. The second distance is smaller than the first distance so that the first rotation shaft 6 has a second space occupation value that corresponds substantially to a second apparent diameter. The second space occupation and the second apparent diameter are smaller than first space occupation and the first apparent diameter. FIG. 18 illustrates a configuration where the secondary portion 6b is no longer salient from the main portion, and the space occupation is minimum.

The spring 8 biases the secondary portion 6b in the direction of the first roller position so that the space occupation of the first rotation shaft 6 is maximum. As the force applied on the roller 5 progressively increases, spring 8 deforms and reduces the space occupation of the first rotation shaft 6. With the reduction of the space occupation of the first rotation shaft 6, the roller 5 moves until it reaches the second roller position. In the second roller position, the roller 5 that was able to rotate in both rotation directions becomes able to rotate in a single rotation direction only.

To obtain clamping of the roller 5 according to its position in the casing, it is possible to provide for a part of the first rotation shaft 6 to have at least one shaft tooth 24 that cooperates with a roller tooth. The roller 5 has one or more roller teeth 25. In the first roller position 5, the at least one shaft tooth 24 is not in contact with the roller teeth 25 as the secondary portion 6b presses on the roller 5 to prevent contact between the teeth 24 and 25. In the second roller position, the secondary portion 6b is retracted and the at least one roller tooth 25 comes into contact with the shaft tooth 24. The orientation of the teeth, for example in a triangle, enables the allowed rotation direction and the prevented rotation direction to be defined when the roller is designed to rotate in one direction only in the second roller position.

As indicated in the foregoing, it is possible to provide a roller 5 mounted rotatable around the first rotation shaft 6 in one rotation direction only. The first rotation shaft 6 is mounted rotatable so as to allow rotation of the roller 5 in both directions. When the roller 5 reaches the second roller position, secondary portion 6b prevents rotation around the first rotation shaft 6 and the roller 5 can rotate in one direction only. The at least one elastic member 8 mounted in the first rotation shaft defines the first force threshold value.

The first rotation shaft 6 can be mounted on a support 13 that is identical or substantially identical to that of FIG. 6, the support 13 being connected to the first flange 1 by a second spring 26. The second spring 26 is chosen with a greater stiffness than that of the first spring 8 so that the roller 5 only allows rotation in a single rotation direction before clamping the rope against the first clamping area 3. The arrangement of the handle 9 can be identical to that set out previously.

In preferential manner, movement of the roller 5 with respect to the deformable rotation shaft is stopped by means of a roller stop. When the roller stop comes into contact with the roller 5, this gives rise to friction enabling the stresses on the configuration of the teeth to be released to have rotation in one direction only. In the particular embodiment illustrated in FIGS. 8 to 18, the rope clamp 10 forms the roller stop. In the embodiment illustrated in FIGS. 8 to 18, the rope clamp 10 is different from the roller 5.

As for the previous embodiments, the roller 5 is mounted movable between a first roller position where rotation in both directions is allowed and a second roller position where rotation is prevented at least in one rotation direction. In the second roller position and in the third roller position, the roller 5 cannot rotate in the direction feeding rope to the climber. The friction with the rope is increased with respect to a rotary roller which facilitates transmission of the force of the rope on the roller 5 and therefore on the rope clamp 10 to clamp the rope against the pad 3.

The roller 5 and the rope clamp 10 are mounted on the support 13. The support 13 is mounted movable in the casing, preferentially movable with respect to the first flange 1. Preferentially, the rope clamp 10 is mounted fixedly on the support 13. Preferably, the support 13 is mounted rotatable around a support shaft 14 fixed to the first flange 1. The roller 5 is eccentric with respect to support shaft 14 so that the force applied on the roller 5 results in rotation of the support 13 and makes the rope clamp 10 move towards the pad 3. The second flange 4 can be mounted rotatable on a flange rotation shaft 27.

In advantageous manner, a support spring 26 is connected on the one hand to the first flange 1 and on the other hand to the support 13. Support spring 26 is arranged to bias the rope clamp 10 away from the pad 3. In other words, the support spring 26 opposes a movement bringing the rope clamp 10 and the pad 3 towards one another. The stiffness of support spring 26 is greater than the stiffness of the first spring 8 so that the rope clamp 10 allows sliding of the rope between the rope clamp 10 and the pad 3 before the roller 5 leaves the second roller position. In other words, when a sufficient force is applied on the roller 5, the roller 5 prevents rotation in one of the rotation directions before the clamp 10 clamps the rope against the first clamping area 3.

In the embodiment illustrated in FIGS. 9 to 18, the first rotation shaft 6 of the roller 5 is mounted eccentric with respect to the support shaft 14 that secures the first rotation shaft 6 with the support 13. It is advantageous to use a first rotation shaft 6 with variable space occupation such as the one represented in FIGS. 16 to 18. As set out in the foregoing, the more the force applied on the roller 5 increases, the more the roller 5 moves from the first roller position to the second roller position. In the second roller position, rotation in at least one of the rotation directions is prevented which gives rise to a strong friction between the rope and the roller 5. As the roller 5 is not able to rotate, the force applied on the roller 5 causes movement of the roller 5, and therefore of the support 13 and the rope clamp 10. The movement of the rope clamp 10 results in movement towards the pad 3 and clamping of the rope if applicable.

In the embodiment illustrated in FIG. 9, the support 13 is mounted movable with respect to the first flange 1 and the support 13 is mounted on the first flange 1. The roller 5 is mounted on the support 13. The roller 5 is fixed to the first flange 1 by means of the support 13. The clamp 10 is mounted fixedly on the support 13. The movement of the clamp 10 follows the movement of the support 13 and vice versa.

As indicated in the foregoing, the handle 9 has a mechanical link with the first flange 1 and the roller 5, for example via the support 13 and/or the first rotation shaft 6. The force applied on the handle 9 during its rotation applies a force between the roller 5 and the casing moving the rope clamp 10 away from the pad 3. In the particular illustrated embodiment, the handle 9 is fitted on the support 13, and preferentially the handle 9 is mounted rotatable around a handle rotation shaft 17 advantageously collaborating with a screw 17a to secure handle rotation shaft 17 on the support 13. As an alternative, the handle 9 can be mounted on the first flange 1 or on another component. The handle 9 can be biased to the first handle position by means of the handle spring 30.

FIG. 10 illustrates a roller 5 in the first roller position and a rope clamp 10 in the first clamp position. The rope can run in both directions and the roller 5 facilitates this running by rotating in both directions to follow the rope. The rope is not stretched. When the tensile load in the rope increases, the force on the roller 5 increases until it reaches the first threshold value. The roller 5 moves to reach the second roller position which blocks at least one rotation direction as illustrated in FIG. 11. Preferentially, the roller 5 comes to press on the roller stop. When the force on the roller 5 increases, the support 13 shifts the rope clamp 10 in the direction of the pad 3 which ensures clamping of the rope. Actuation of the handle 9 shifts the support 13 to move the latter away from the pad 3 and achieve sliding of the rope.

In the illustrated embodiments, the roller 5 is mounted rotatable around a first axis of rotation that is perpendicular or substantially perpendicular to the first surface 1a of the first flange 1. In operation, the rope moves within the rope running channel. The rope running channel is arranged so that the rope presses on two delineators 7 fixed to the first flange 1 or to the second flange 4. The delineators 7 are separated by the roller 5 along the running path of the rope. When the rope is stretched, it presses on delineators 7 and on the roller 5 which applies a force on the roller 5 urging the latter to the second roller position.

In the illustrated embodiments, the handle 9 is designed to be actuated by means of the left hand. The rope strand that has to exit via the right-hand aperture is designed to be attached to the climber and corresponds to the up-line strand. The rope strand that has to exit via the left-hand aperture is designed to feed or take up excess rope. A reverse architecture of a belay device for actuation of the handle 9 with the right hand is possible.

In the illustrated embodiment, the attachment point 2 is located under the roller 5. However, it is also possible to have an attachment point 2 that passes through the roller 5 which is apertured accordingly. However, this embodiment is less advantageous as it requires a more bulky connector to attach the belay device to the attachment point. It is advantageous to have an attachment point in the second flange 4 so that the connector closes the belay device.

It is particularly advantageous to keep the ability of the roller 5 to rotate in the first rotation direction even when the rope is clamped as this makes it easier to take up rope slack to assist the climber without impairing safety. For comparison purposes, in belay devices detecting the speed of rotation of the roller 5 to block the roller 5, once the roller 5 is blocked and the rope is tensioned, the user does not know whether his next action on the belay device will have the consequence of releasing blocking of the roller 5 and therefore possibly meaning that the climber will fall again in case of incorrect handling although the rope is taut.

The method for using the belay device is as follows. A rope loop is installed in the belay device, the rope loop passing round the roller 5. Due to the fact that the tension in the rope is lower than a first threshold value, the roller 5 is in a first roller position. Running of the rope in one direction and then in the opposite direction causes rotation of the roller 5 in one rotation direction and then in the other rotation direction. The tension in the rope increases inside the belay device and applies a force on the roller 5 in the direction directed to the opening of the casing. The roller 5 moves until the second roller position is reached. Running of the rope in the direction of the climber does not result in rotation of the roller 5 around its axis of rotation. The increased tension in the rope results in movement of the roller 5 to the third roller position and clamping of the rope.

Rotation of the handle 9 enables the rope clamp 10 to be moved with respect to the pad 3, the roller 5 being at least clamped in one rotation direction. Movement of the rope clamp 10 with respect to the pad 3 modulates the separating distance and therefore the friction that exists between the rope, the rope clamp 10, the pad 3 and the roller 5 to modulate the feed rate of the rope.

The belay device blocks the rotation of the roller when the tension in the rope reaches a threshold value. The belay device blocks the rotation of the roller 5 when the roller 5 is separated from a rest position of the roller by a threshold distance. The rest position of the roller is a position of the roller corresponding to a rope free of tension. The first spring 8 transforms the tension in the rope into a position of the roller 5 in the casing and thus transforms the tension in the rope into a distance of the roller 5 from a rest position.

1. A belay device comprising:
a casing designed to receive a rope loop, the casing defining at least one opening for strands of the rope loop to pass through and an attachment point designed to attach the belay device to an anchor point;
a pad fixed to the casing and delineating the at least one opening;
a roller fixed to the casing by means of a first rotation shaft and arranged in the casing, the roller being mounted rotating in two rotation directions, the roller being mounted movable in the casing, along a first direction of movement between a first roller position, a second roller position and a third roller position, the second roller position being closer to the at least one opening than the first roller position, the third roller position being closer to the pad than the second roller position, the first rotation shaft being mounted movable with respect to the casing and/or deformable in order to move the roller in the casing;
a rotation clamp configured to allow rotation of the roller in both rotation directions when the roller is in the first roller position, the rotation clamp being configured to block at least one of the two rotation directions of the roller when the roller is in the second roller position and when the roller is in the third roller position, the roller and/or the first rotation shaft being in contact with a stop fixed to the casing to block said at least one of the two rotation directions of the roller when the roller is in the second roller position and when the roller is in the third roller position, the roller and/or the first rotation shaft being at a distance of said stop when the roller is in the first roller position; a first spring having a first end coupled to the casing and a second end coupled to the roller to bias the roller toward the first roller position, the first spring transforming a force of the loop of rope on the roller into a position of the roller in the casing, the first spring forming all or part of a mechanical link connecting the roller with the casing, the first spring moving the roller away from the at least one opening; rope loop against the pad when the roller is in the third roller position, a position of the rope clamp depending on a position of the roller at least when the roller is between the second roller position and the third roller position; a handle mounted movable between a first handle position and a second handle position, the handle being fixed to the casing; wherein in the third roller position, the handle is functionally coupled to the casing and to the roller so that a force applied on the handle to move the handle generates a force on the roller to move the roller away from the opening.

2. The belay device according to claim 1 wherein the roller is provided with a toothed wheel and a hook is mounted on the casing, the toothed wheel being in contact with the hook when the roller is in the second roller position and the toothed wheel being at a distance from the hook when the roller is in the first roller position, the hook and the toothed wheel forming the rotation clamp.

3. The belay device according to claim 2 wherein the hook is mounted movable with respect to the casing between a first hook position and a second hook position, wherein when the hook is in a first hook position and the roller is in the second roller position, the toothed wheel is in contact with the hook and wherein when the hook is in a second hook position and the roller is in a third roller position, the toothed wheel is in contact with the hook.

4. The belay device according to claim 3 comprising a hook spring applying a force on the hook, the hook spring placing the hook in the first hook position in the absence of any outside force being applied.

5. The belay device according to claim 1 wherein the handle is configured so that a rotation of the handle from the first handle position to the second handle position moves the roller over a smaller distance than the first distance so that actuation of the handle does not allow rotation of the roller in both rotation directions.

6. The belay device according to claim 1 wherein the roller is mounted movable to a position where the pad inserts in a groove of the roller.

7. The belay device according to claim 1 wherein the roller is mounted rotatable around a first rotation shaft and the first rotation shaft is mounted rotatable around a second axis of rotation, wherein the first spring applies a force on the first rotation shaft in the direction of the first roller position and the first rotation shaft is mounted on a support and wherein the support is mounted rotatable on a support rotation shaft and a support spring applies a force on the support to move the pad away from a rope clamp fixed to the support.

8. The belay device according to claim 7 wherein the first rotation shaft and the support are mounted rotatable around the support rotation shaft.

9. The belay device according to claim 1 wherein, the roller rotates around a first rotation shaft and wherein the first spring is configured to adjust the space occupation of the rotation shaft perpendicularly to the axis of rotation of the roller by means of the first spring, the first spring being configured to apply a force on the first rotation shaft and to shift the axis of rotation and the roller in the direction of the first roller position.

10. The belay device according to claim 1 comprising an additional rotation clamp configured to block rotation of the roller when the additional rotation clamp detects that the speed of rotation of the roller reaches a threshold value.

11. A method for using a belay device comprising the following steps: providing a belay device according to claim 1,
installing a rope loop in the belay device, the rope loop passing round the roller,
the tension in the rope being lower than a first threshold value, making the rope run in one direction and then in the opposite direction to make roller rotate in one rotation direction and then in the other rotation direction;
increasing the tension in the rope until the roller reaches the second roller position, the roller blocking at least one rotation direction,
further increasing the tension in the rope until the rope is clamped.
